(19) United States
(12) Patent Application Publication
(10) Pub. No.: US 2020/0170286 A1
(43) Pub. Date: Jun. 4, 2020

(54) METHOD OF PROCESSING SEEDS TO NUTRITIONALLY ENHANCE FOOD

(71) Applicant: Robert den Hoed, Sioux Center, IA (US)

(72) Inventor: Robert den Hoed, Sioux Center, IA (US)

(21) Appl. No.: 16/781,479

(22) Filed: Feb. 4, 2020

Related U.S. Application Data
(63) Continuation of application No. 14/803,613, filed on Jul. 20, 2015, now abandoned.
Application No. 14/803,613 is a continuation-in-part of application No. 13/737,584, filed on Jan. 9, 2013, now abandoned.

(51) Int. Cl. A23L 7/10; A23L 25/00; A23L 33/135; A23L 7/20; A23L 33/00; A23L 7/109; A23L 33/10; A23L 7/143; A21D 2/38; A21D 6/00

(52) U.S. Cl. CPC A23L 7/198; A23L 25/30; A23L 33/135; A23L 7/20; A23L 33/40; A23V 2002/00; A23L 33/10; A23L 7/143; A23L 25/20; A21D 2/38; A21D 6/001; A23L 7/109

(57) ABSTRACT

A method of processing seed to nutritionally enhance food where seeds are placed in a tank and sanitized, and then washing and hydrating the seeds. The seeds are then allowed a period of germination before the seeds are dried for a predetermined amount of time and cooled.

### CROSS REFERENCE TO A RELATED APPLICATION

This application is a continuation-in-part of U.S. patent application Ser. No. 13/737,584 filed Jan. 9, 2013.

### BACKGROUND OF THE INVENTION

The present invention is directed to a method of processing seeds and more particularly to a method of processing seeds to enhance the nutritional qualities of food, expression of prebiotic and probiotic microflora.

Methods of processing seeds are well known in the art. Conventional methods of processing seeds leave many desired qualities unrealized. Sprouted seeds and grains are a substantial source of nutrients. However, these nutrients, such as activated enzymes and essential fatty acids, are unavailable prior to the seed sprouting due to natural inhibitors that protect it from digestion that are not present during the sprouting process. The presence of these inhibitors prevents methods such as milling and grinding of raw sprouted seeds and grain seeds from obtaining the nutrients locked within the seed.

The failure of current methods to produce products that have activated enzymes misses a key feature nutrient within seeds. These enzymes are useful in the elimination of toxins, the construction of new tissues and cells, regulation of systemic metabolism, and digestion. The addition of these enzymes becomes more important as individuals age and are less capable of developing these enzymes on their own.

Additionally, the use of milling and grinding to unlock some of the nutrients has negative consequences. Namely, the ground and milled seeds require special packaging and storage to maintain stability and prevent the seeds from becoming rancid.

It is also desired to have a method of processing seeds with a higher heat tolerance to maintain the nutritional value of the seeds, express probiotics and prebiotic expression. Currently in the art, conventional methods produced sprouted seeds and grains that are unable to be used in cooking and baking at high temperatures and therefore cannot be incorporated into a number of goods unless special cooking methods are developed that are time consuming, expensive, or cumbersome are utilized.

Other qualities are also desired that conventional methods cannot realize. For example, it is desired to process seeds in a manner that creates a higher chelation of minerals and enhance enzyme expression and high fiber for better absorption of nutrients by the human body. Also desired is a method of processing seeds that results in lower fat and lower phytic acid.

Therefore, an objective of the present invention is to provide a method of processing seeds such that minerals liberated and connected to proteins for better absorption by the body and enzymes are better expressed and enhanced.

A further objective of the present invention is to provide a method of processing seeds that changes a starch to a simple sugar and expand the beneficial nature of probiotics and prebiotics found on germinated seeds.

These and other objectives will be apparent to one of ordinary skill in the art based upon the following written description, drawings, and claims.

### SUMMARY OF THE INVENTION

A method of processing seeds where after the seeds are sanitized, washed and hydrated, the seeds are subjected to a period of germination prior to drying and cooling. By permitting the seed to germinate and sprout not only is the mineral connection and enzymes liberated and enhanced to proteins improved, but by allowing the seed to sprout, starches are changed to simple sugars as well as prebiotics and probiotics expressed. The method enhances and elevates the nutritional and beneficial microflora value of the seed for use in food, but also puts seed in a better form for absorption in the body. Seed produced by this method preferably is used as an ingredient in infant food, in infant cereals, in other hot and cold cereals, in frozen dough, and for dry mixes and flours.

When compared to nonsprouted seeds and grains, sprouted seeds and grains using the disclosed method demonstrate a superiority in nutritional value in nearly every category:

Nonsprouted Seeds & Grains Compared to Sprouted Seeds & Grains

| | % Δ With Nonsprouted |
|---|---|
| Enzymes | |
| Amylase | +30% |
| Lipase | +322% |
| Cellulase | +700% |
| Protease | +860% |
| Vitamins | |
| B2 | +74% |
| B3 | +21% |
| B5 | +15% |
| B6 | +33% |
| B12 | +120% |
| Beta-carotene | + over 1000% |
| Biotin | +483% |
| C | +925% |
| Choline | + over 1000% |
| E | +9660% |
| Folic Acid | +273% |
| Lipids | |
| Polyunsaturated Fat | +4% |
| Monounsaturated Fat | −12% |
| Saturated Fat | −9% |
| Omega-3 EFA | +31% |
| Lignans | |
| Lignans | +15% |
| Proteins | |
| Protein | +25% |
| Aminio Acids | |
| Alanine | +161% |
| Arginine | +122% |
| Apartic Acid | +124% |
| Cystine | +218% |
| Glutamic Acid | +113% |
| Glycine | +105% |
| Histidine | +136% |
| Isoleucine | +145% |
| Leucine | +128% |
| Lysine | +130% |
| Methionine | +153% |
| Phenylalanine | +128% |
| Proline | +553% |
| Serine | +143% |
| Threonine | +131% |
| Trytophan | +130% |
| Tyrosine | +225% |
| Valine | +237% |

### BRIEF DESCRIPTION OF THE DRAWINGS

FIG. 1 is a schematic drawing of the environment of performing a method of processing seeds; and

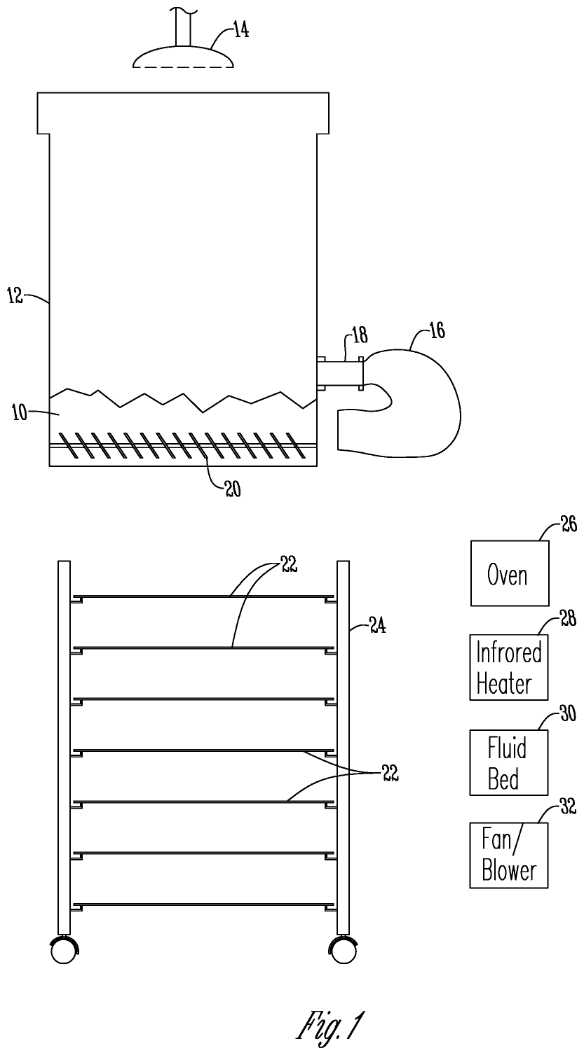

FIG. 2 is a flow diagram of a method of processing seeds.

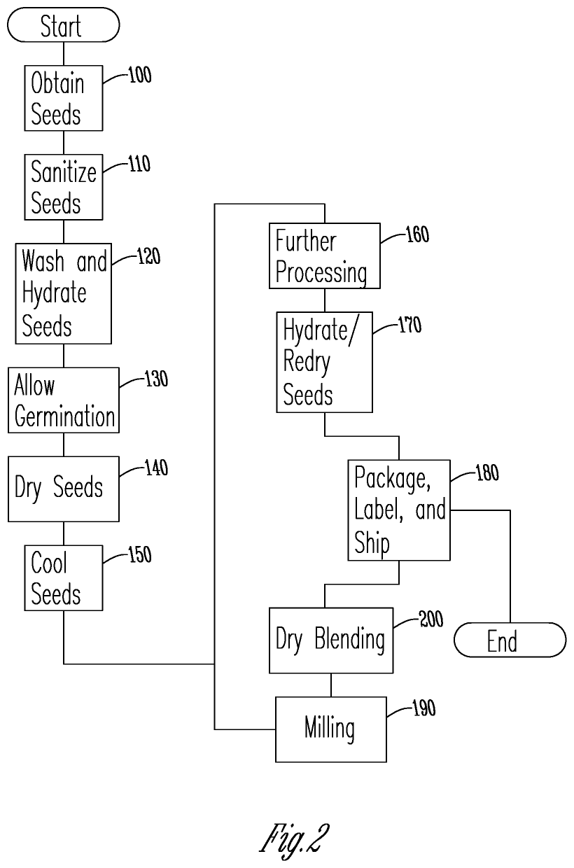

### DETAILED DESCRIPTION OF THE PREFERRED EMBODIMENTS

Referring to the Figures, a method of processing seeds to nutritionally enhance food begins at step 100 by obtaining seeds 10 from any conventional source. The seeds are of any type and include, but are not limited to, wheat, rye, barley, triticale, rice, quinoa (white, red, and black), oats and oat grouts, buckwheat and grouts, soybean, lentils (red, green, and French), garbanzo beans, flax (brown an golden), chia, corn, millet, amaranth, pea, pumpkin, spelt, kamut, or the like.

Once obtained, the seeds 10 are placed in a tank 12 where the seeds are sanitized at step 110. Preferably, the seeds 10 are sanitized by treating the seeds with any organically approved sanitation product such as calcium and hypochlorite or the like. Once sanitized, the tank 12 is drained and the seeds 10 are washed and hydrated with water at step 120, preferably by using small sprayers or misters 14. In one embodiment, the seeds are washed for at least one minute but less than seven days. In an alternative embodiment, the seeds are washed for at least one minute but no more than five hours. In another embodiment, the seeds are washed for at least one minute but no more than four hours. In yet another embodiment, the seeds are washed for at least twelve hours and no more than seven days.

Once the seeds are washed and hydrated, they are set aside for a germination period at step 130. The germination period preferably lasts between one minute and seven days depending upon the type of seed, amount of hydration, and/or temperature. In one embodiment, the seeds are set aside to germinate for a period of at least eleven hours and no more than three days. In one embodiment, the seeds are allowed to germinate for a period greater than one day (twenty-four hours). If seeds are not allowed to germinate for longer than ten hours, the seeds nutritional levels cannot reach their peak. Conversely, allowing the seeds to germinate for periods longer than necessary results in the nutrients in the seeds to deplete as the seed will begin to use the nutrients.

Further, the germination period can be done without or with air circulation to provide more oxygen to the seeds. Preferably, air circulation is provided by a fan 16 that is connected to the tank 12 by tubing 18 or by a rotating auger 20 placed in the tank 12.

When the germination period is completed, the seeds 10 are removed from the tank 12 and placed on trays 22, which are positioned on racks 24, and then dried at step 140. The drying of the germinated seeds preferably is done in an oven 26 having airflow, an infrared heater 28, or a fluid bed 30 having an auger that vibrates the seeds as hot air withdraws the moisture. The drying period ends when the temperature of the seeds is between 90 and 3500° F. In one embodiment, the seeds are dried at a temperature of 180° F. to eliminate potential pathogens, but maintain probiotics. In alternative embodiments, temperatures of at least 140 and no more than 185° F. are used to dry.

In order to maintain the nutrient value of the seeds, a longer duration of drying is needed—for example a period greater than one hour. For instance, in one embodiment the seeds are dried for a period of at least twelve hours and no more than 24 hours in order to express and maintain the prebiotics, the probiotics, live enzymes, active ligan, rutin, and quenercin (found in buckwheat) and other nutrients found in the sprouting attributes. A shorter drying period, for instance, a period of thirty minutes, would result in the destruction of much of this nutritional value and therefore a slow drying process is critical.

Once dried, the seeds 10 are cooled at step 150, either in ambient air or incoming circulated air from a fan or blower 32. After the seeds 10 have cooled, they are, in one embodiment, subjected to further processing at step 160. The further processing includes grinding, blending or flaking, with or without non-sprouted seeds, flours, or superfruits. At step 170, the processed seeds are hydrated and/or redried to make the processed seed compatible for freezing, cereals, or doughs. Finally, at step 180, the processed seeds are packaged, labeled, and shipped.

Alternatively, after the seeds 10 have cooled, at step 190, the seeds are milled. Once milled, at step 200, the milled seeds are dry blended with other grains. Finally, the blended mixture is packaged and labeled at step 180.

At step 210, the processed seeds or milled seeds are cooked or baked into a product such as a cooked or baked good. In one embodiment, the processed seeds are cooked to an internal temperature between 140 and 185° F. Cooking at higher temperatures, such as these, is critical to killing potential pathogens. Previous methods were unable to produce processed seeds capable of being heated to internal temperatures this high without significant nutrient loss.

For illustrative purposes, sprouted flax, barley, wheat, quinoa, and 9 grain produced using the disclosed method were tested and subsequently heat tested to determine nutrient degradation. As shown in the charts below, insignificant degradation occurred thereby demonstrating the suitability of the processed seeds of the disclosed method for use in high-temperature scenarios.

Before Heat Treatment (As Is)

| Test | S. Flax | S. Barley | S. Wheat | S. Quinoa | S. 9 Grain |
|---|---|---|---|---|---|
| Probiotics | 36,000,000 | 34,000,000 | 30,000,000 | 33,000,000 | 31,000,000 |
| (Total Load) | | | | | |
| cfu/g | | | | | |
| Prebioitics | 33 | 32 | 27 | 28 | 34 |
| (FOS) mg/g | | | | | |
| Enzymes | 455 | 452 | 389 | 393 | 452 |
| (Lipase) | | | | | |
| LU/g | | | | | |
| Vitamins | 1.65 | 5.00 | 3.36 | 1.85 | 3.40 |
| (Niacin) | | | | | |
| mg/100 g | | | | | |
| Minerals | 7.22 | 8.93 | 2.95 | 8.64 | 8.95 |
| (Iron) | | | | | |
| ing/100 g | | | | | |

Post Heat Treatment

| Test | S. Flax | S. Barley | S. Wheat | S. Quinoa | S. 9 Grain |
|---|---|---|---|---|---|
| Probiotics | 33,000,000 | 32,000,000 | 30,000,000 | 30,000,000 | 29,0000,000 |
| (Total Load) | | | | | |
| cfu/g | | | | | |
| Prebioitics | 32 | 30 | 25 | 27 | 31 |
| (FOS) mg/g | | | | | |
| Enzymes | 452 | 450 | 383 | 394 | 448 |
| (Lipase) | | | | | |
| LU/g | | | | | |
| Vitamins | 1.61 | 4.97 | 3.30 | 1.84 | 3.39 |
| (Niacin) | | | | | |
| mg/100 g | | | | | |
| Minerals | 7.10 | 8.81 | 2.87 | 8.62 | 8.92 |
| (Iron) | | | | | |
| mg/100 g | | | | | |

Accordingly, a method of processing seeds to nutritionally enhance food and prebiotic and probiotic microflora has been disclosed that, at the very least, meets all the stated objectives.

What is claimed is:

1. A method of processing seeds to nutritionally enhance food and its prebiotic and probiotic microflora, comprising the steps of:
placing a plurality of seeds in a tank and sanitizing the seeds;
washing and hydrating the seeds with water;
allowing the seeds to germinate over a period of time;
drying the seeds for a predetermined amount of time; and
cooling the seeds.

2. The method of claim 1 further comprising the step of subjecting the seeds to further processing.

3. The method of claim 1 further comprising the step of milling the seeds

4. The method of claim 1 further comprising the steps of milling the seeds and dry mixing the milled seeds with other grains.

5. The method of claim 1 wherein the step of drying the seeds includes drying the seeds until the seeds reach a temperature between 90 and 350° F.

6. The method of claim 1 wherein the step of allowing the seeds to germinate includes providing air circulation to the seeds.

7. The method of claim 1 wherein the step of drying the seeds includes using at least one drying device selected from the group consisting of an oven, an infrared heater, and a fluid bed.

8. The method of claim 1 wherein the step of cooling the seeds include providing incoming air circulation.

9. The method of claim 1 further comprising the step of blending the seeds with superfruits.

10. The method of claim 1 further comprising the step of rehydrating the seeds.

11. The method of claim 1 further comprising the steps of rehydrating and redrying the seeds.

12. The method of claim 1 further comprising the step of heating the seeds to an internal temperature between 140 and 185° F. in the process of making a product.

13. The method of claim 1 wherein the seeds are dried for a predetermined time of at least twelve hours and no more than 24 hours.

14. The method of claim 1 wherein the seeds are dried for a predetermined time greater than one hour.

15. The method of claim 1 wherein the seeds are dried at a temperature of 180° F.

16. The method of claim 1 wherein the seeds are allowed to germinate for 11 hours.

17. The method of claim 1 wherein the seeds are allowed to germinate for a period greater than 24 hours.
